(19) United States
(12) Patent Application Publication
(10) Pub. No.: US 2009/0135094 A1
(43) Pub. Date: May 28, 2009

(54) Plasma Display Device and Method of Driving the Same

(76) Inventors: Masayuki Shibata, Yokohama (JP); Katsumi Ito, Yokohama (JP); Naoki Itokawa, Yokohama (JP); Tomonari Misawa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/185,142

(22) Filed: Aug. 4, 2008

(30) Foreign Application Priority Data
Nov. 26, 2007 (JP) 2007-305015

(51) Int. Cl. G09G 3/10

(52) U.S. Cl. 345/42

(57) ABSTRACT

A plasma display device capable of realizing an interlace drive in one line display and an interlace drive in two lines display by switching thereof without deteriorating display quality, is provided. The interlace drive in one line display and the interlace drive in two lines display are realized such that: the interlace drive in one line display is performed by applying a sustain pulse for even display lines or odd display lines within a plasma display panel in each frame; and the interlace drive in two lines display is performed by applying the sustain pulse while setting the even display lines and the odd display lines adjacent above and below as one set and writing an identical data thereto. In addition, the all-cell reset is performed once per unit time at the interlace drive in two lines display, and an increase of background luminance is prevented by suppressing the increase in the number of times of the all-cell reset in the two lines display.

### CROSS-REFERENCE TO RELATED APPLICATIONS

This application is based upon and claims the benefit of priority from the prior Japanese Patent Application No. 2007-305013, filed on Nov. 26, 2007, the entire contents of which are incorporated herein by reference.

### BACKGROUND OF THE INVENTION

The present invention relates to a plasma display device and a method of driving the same.

One frame (odd frame or even frame) is constituted by plural sub-frames, and a gradation expression is realized by selecting the sub-frame in which a cell is lighted, in a drive of a plasma display panel (PDP). Besides, each sub-frame is constituted by a reset period initializing a wall charge state on an electrode, an address period adjusting the wall charge state based on a display data and performing a selection of the cell to be lighted, and a sustain period lighting the cell corresponding to the display data (the cell selected in accordance with the display data is discharge light-emitted).

Further, there are an all-cell reset (all cells simultaneous initialization) and an on-cell reset in a reset discharge performed during the reset period. In the all-cell reset, the reset discharge is performed at both of the cells which are lighted and the cells which are not lighted during the sustain period of a preceding sub-frame, namely at all cells regardless of whether a sustain discharge is performed or not during the sustain period of the preceding sub-frame. In the on-cell reset, the reset discharge is performed only at the cells which are lighted during the sustain period of the preceding sub-frame, namely only at the cells in which the sustain discharge is performed during the sustain period of the preceding sub-frame.

Besides, in the plasma display panel, an interlace drive is performed such that display lines are divided into odd display lines and even display lines, and the odd display lines are lighted at odd frames, and the even display lines are lighted at even frames. Besides, an art is proposed in which adjacent two lines being one odd display line and one even display line are set as one set, the identical one line data is written thereto, and luminance improvement in the interlace drive is realized by appropriately controlling whether only one line is made to emit light or two lines are made to emit light simultaneously in accordance with a display load ratio and so on (for example, refer to International Publication No. 07/004305 pamphlet).

### SUMMARY OF THE INVENTION

In a conventional plasma display panel, an all-cell reset is certainly performed for display lines in which a sustain discharge is performed in a frame, at a head sub-frame among plural sub-frames constituting the frame. Background luminance in the plasma display panel is generated resulting from a discharge in the all-cell reset.

Accordingly, when the adjacent two lines are set as one set, the identical one line data is written thereto, and two lines are made to emit light simultaneously (two lines display) as stated above, the number of times of the all-cell reset increases and the background luminance becomes high compared to a case when the lines are made to emit light one by one alternately to perform a display (one line display). Besides, a switching shock occurs caused by a change in the background luminance when the state in which two lines are made to emit light simultaneously and the state in which the lines are made to emit light one by one alternately are switched.

An object of the present invention is to provide a plasma display device capable of realizing the interlace drive in one line display and the interlace drive in two lines display by switching thereof without deteriorating display quality.

A plasma display device of the present invention, includes: a plasma display panel in which display electrode pairs of even display lines and display electrode pairs of odd display lines are arranged alternately; and a driving unit performing an interlace drive by applying a sustain pulse to one of the display electrode pairs either the display electrode pair of the even display lines or the display electrode pair of the odd display lines in each frame in a first mode, and performing the interlace driving by applying the sustain pulse while setting the two display electrode pairs of the even display lines and the odd display lines adjacent above and below as one set, and writing an identical data thereto in a second mode, and wherein an all-cell reset performing a reset discharge initializing a wall charge state on an electrode at all cells is performed once per unit time including plural frames, when the plasma display panel is driven in the second mode.

A driving method of a plasma display device of the present invention, having a plasma display panel in which display electrode pairs of even display lines and display electrode pairs of odd display lines are arranged alternately, includes: detecting a display load ratio of the plasma display panel, and selecting a first mode or a second mode in accordance with the detected display load ratio; performing an interlace drive by applying a sustain pulse to one of the display electrode pairs either the display electrode pair of the even display lines or the display electrode pair of the odd display lines in each frame in the first mode; performing the interlace drive by applying the sustain pulse while setting the two display electrode pairs of the even display lines and the odd display lines adjacent above and below as one set, and writing an identical data thereto in the second mode; and performing an all-cell reset in which a reset discharge initializing a wall charge state on an electrode is performed at all cells once per unit time including plural frames when the plasma display panel is driven in the second mode.

The interlace drive in one line display can be performed by applying the sustain pulse to one of display electrode pairs either the even display lines or the odd display lines in each frame. Besides, the interlace drive in two lines display can be performed by applying the sustain pulse while setting two display electrode pairs of the even display lines and the odd display lines adjacent above and below as one set, and writing an identical data thereto. Further, the all-cell reset in which the reset discharge is performed at the all cells is performed once per unit time including plural frames at the interlace drive time in two lines display, and therefore, it is possible to suppress that the number of times of the all-cell reset increases, to prevent that the background luminance becomes high, and to suppress a deterioration of display quality.

### BRIEF DESCRIPTION OF THE DRAWINGS

FIG. 1 is a view showing a configuration example of a plasma display device according to an embodiment of the present invention;

FIG. 2 is a view showing a configuration example of a plasma display panel in the present embodiment;

FIG. 3 is a view for explaining a disposition of display electrodes in the plasma display panel in the present embodiment;

FIG. 4 is a view for explaining a driving method of the plasma display panel;

FIG. 5A and FIG. 5B are views for explaining an example of a driving method of the plasma display device in the present embodiment;

FIG. 6A and FIG. 6B are views for explaining another example of the driving method of the plasma display device in the present embodiment;

FIG. 7A and FIG. 7B are views for explaining the other example of the driving method of the plasma display device in the present embodiment;

FIG. 8A is a view showing an example of driving waveforms of the plasma display device in the present embodiment;

FIG. 8B is a view showing an example of driving waveforms of the plasma display device in the present embodiment;

FIG. 8C is a view showing another example of driving waveforms during a reset period in the present embodiment;

FIG. 9 is a view for explaining a constitution of a sub-frame in the present embodiment;

FIG. 10 is a view showing an example of a mixing ratio control in two lines lighting;

FIG. 11 is a view for explaining an APC control;

FIG. 12 is a view showing an example of the mixing ratio control of the two lines lighting;

FIG. 13A and FIG. 13B are views showing another example of the mixing ratio control of the two lines lighting;

FIG. 14 is a view showing the other example of the mixing ratio control of the two lines lighting;

FIG. 15 is a view showing voltage waveforms used for a discharge delay test; and

FIG. 16 is a view showing a relation between an idle period and a discharge delay as for a plasma display panel manufactured by using MgO (magnesium oxide) crystallization to which fluorine is added.

### DETAILED DESCRIPTION OF THE PREFERRED EMBODIMENTS

Hereinafter, embodiments of the present invention are described based on the drawings.

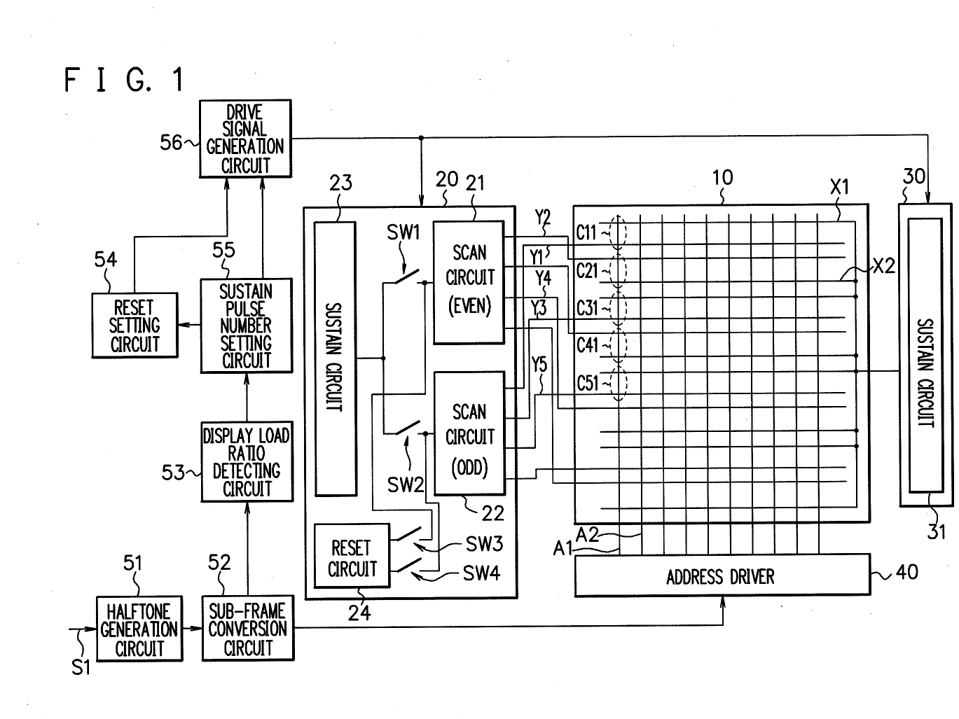

FIG. 1 is a block diagram showing a configuration example of a plasma display device according to an embodiment of the present invention. The plasma display device according to the present embodiment has a plasma display panel 10, a Y electrode driver 20, an X electrode driver 30, an address driver 40, a halftone generation circuit 51, a sub-frame conversion circuit 52, a display load ratio detecting circuit 53, a reset setting circuit 54, a sustain pulse number setting circuit 55, and a drive signal generation circuit 56.

The Y electrode driver 20 is a circuit driving Y electrodes (scan electrodes) Y1, Y2, . . . among display electrodes, and has a scan circuit (even) 21, a scan circuit (odd) 22, a sustain circuit 23, and a reset circuit 24. Hereinafter, each of the Y electrodes Y1, Y2, . . . , or a generic thereof is called as a Y electrode Yi, in which “i” means a subscript.

The scan circuits 21, 22 are constituted by circuits selecting a row to be displayed by performing a line-sequential scanning. The sustain circuit 23 is constituted by a circuit repeating a sustain discharge. A predetermined voltage is supplied to the plural Y electrodes Yi by the scan circuits 21, 22, and the sustain circuit 23.

The scan circuit (even) 21 is provided so as to correspond to the even-th Y electrodes Y2, Y4, . . . relating to even display lines among display lines, and supplies a drive voltage to the Y electrodes Y2, Y4, . . . . The scan circuit (even) 21 operates so that scan pulses are sequentially applied to the Y electrodes Y2, Y4, . . . during an address period, and sustain pulses from the sustain circuit 23 are simultaneously applied to the Y electrodes Y2, Y4, during a sustain period, at least at even frames lighting the even display lines.

Besides, similarly, the scan circuit (odd) 22 is provided so as to correspond to the odd-th Y electrodes Y1, Y3, Y5, . . . relating to odd display lines, and supplies a drive voltage to the Y electrodes Y1, Y3, Y5, . . . . The scan circuit (odd) 22 operates so that scan pulses are sequentially applied to the Y electrodes Y1, Y3, . . . during the address period, and sustain pulses from the sustain circuit 23 are simultaneously applied to the Y electrodes Y1, Y3, . . . during the sustain period, at least at odd frames lighting the odd display lines.

Besides, the scan circuit (even) 21 and the sustain circuit 23 are connected via a switch SW1, and the scan circuit (odd) 22 and the sustain circuit 23 are connected via a switch SW2. The switches SW1, SW2 are independently on/off controlled based on a control signal and so on from the drive signal generation circuit 56.

It is possible to respectively switch whether an output from the sustain circuit 23 is supplied to the scan circuits 21, 22 or not by independently the switches SW1, SW2. More specifically, it is possible to switch whether the output from the sustain circuit 23 is applied to the even-th Y electrodes Y2, Y4, . . . or not by the switch SW1, and to switch whether the output from the sustain circuit 23 is applied to the odd-th Y electrodes Y1, Y3, . . . or not by the switch SW2. Besides, it is possible to make the even-th Y electrodes Y2, Y4, . . . , and the odd-th Y electrodes Y1, Y3, . . . high-impedance states independently by turning the switches SW1, SW2 into off states.

The reset circuit 24 is constituted by a circuit initializing a wall charge state, and applies a predetermined voltage to the plural Y electrodes Yi. The reset circuit 24 is connected to the scan circuit (even) 21 via a switch SW3, and connected to the scan circuit (odd) 22 via a switch SW4. The switches SW3, SW4 are on/off controlled based on the control signal and so on from the drive signal generation circuit 56, and thereby, the reset circuit 24 controls so that the predetermined voltage is applied to one of sets either a set of the odd-th Y electrodes Y1, Y3, . . . or a set of the even-th Y electrodes Y2, Y4, . . . , or the predetermined voltage is applied to all of the Y electrodes Y1, Y2, Y3, Y4, . . . , in accordance with a display load ratio.

The X electrode driver 30 is a circuit driving X electrodes (sustain electrodes) X1, X2, . . . among the display electrodes, and has a sustain circuit 31. Hereinafter, each of the X electrodes X1, X2, . . . , or a generic thereof is called as an X electrode Xi, in which “i” means a subscript. The sustain circuit 31 is constituted by a circuit repeating the sustain discharge, and supplies a predetermined voltage to the X electrode Xi. One ends of the X electrodes Xi are commonly connected to the X electrode driver 30.

The address driver 40 is constituted by a circuit selecting a column to be displayed, and supplies a predetermined voltage to plural address electrodes A1, A2, . . . . Hereinafter, each of the address electrodes A1, A2, . . . , or a generic thereof is called as an address electrode Aj, in which “j” means a subscript.

A video signal S1 in digital format is inputted to the halftone generation circuit 51, and the halftone generation circuit 51 performs an error diffusion process, a dither process, and so on to generate a halftone, so as to display the video signal S1 with limited lighting patterns. The sub-frame conversion circuit 52 selects the lighting pattern of the sub-frame based on the video signal outputted from the halftone generation circuit 51, and converts the video signal into the lighting pattern corresponding thereto. The address driver 40 generates a voltage applied to the address electrode Aj to select the sub-frame to be lighted as for each pixel, in accordance with the lighting pattern outputted from the sub-frame conversion circuit 52.

The display load ratio detecting circuit 53 calculates the display load ratio by each field based on the lighting pattern outputted from the sub-frame conversion circuit 52. The display load ratio is detected based on the number of light-emitting pixels and a gradation value of the light-emitting pixels. The display load ratio when all pixels of an image are displayed with maximum gradation values is set as 100%.

The sustain pulse number setting circuit 55 selects whether the one line display is performed or the two lines simultaneous display is performed in accordance with the display load ratio detected by the display load ratio detecting circuit 53. At the same time, the sustain pulse number setting circuit 55 determines a mixing ratio of a period when the one line display is performed and a period when the two lines simultaneous display is performed, when the two lines simultaneous display is performed. Accordingly, the number of sustain pulses to be applied for each display line in each sub-frame within the frame is set.

The reset setting circuit 54 sets the frame in which the all-cell reset is performed based on an output from the sustain pulse number setting circuit 55. Namely, the reset setting circuit 54 determines an execution of the all-cell reset, an execution of the on-cell reset, or an inexecution of the reset as for each frame based on the output from the sustain pulse number setting circuit 55.

The drive signal generation circuit 56 generates a drive signal relating to the Y electrode driver 20 and the X electrode driver 30 in accordance with the outputs of the reset setting circuit 54 and the sustain pulse number setting circuit 55.

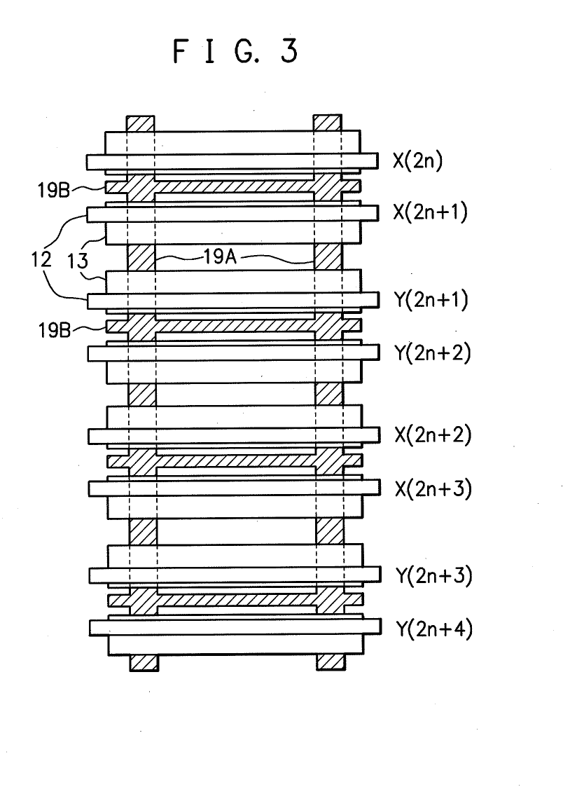

In the plasma display panel 10, the Y electrode Yi and the X electrode Xi constituting a display electrode pair form a row extending in parallel in a horizontal direction, and the address electrode Aj forms a column extending in a vertical direction. The Y electrodes Yi and the X electrodes Xi are disposed in a predetermined disposition pattern in the vertical direction and in parallel with each other (the disposition pattern of the display electrodes will be described later with reference to FIG. 3). The address electrodes Aj are disposed in approximately the vertical direction relative to the Y electrodes Yi and the X electrodes Xi. The Y electrode Yi and the address electrode Aj form a two dimensional matrix of i-row j-column.

Here, in the plasma display panel 10 in the present embodiment, the display electrode pair constituted by two electrodes (a pair of Y electrode Yi and the X electrode Xi) is disposed for one display line, and the display electrode is not shared by adjacent display lines. Namely, when “p” is a natural number, the odd display line in the display lines is constituted by a set of the Y electrode Y(2p−1) and the X electrode X(2p−1), and the even display line is constituted by a set of the Y electrode Y(2p) and the X electrode X(2p). For example, a first display line is constituted by a set of the Y electrode Y1 and the X electrode X1, and a second display line is constituted by a set of the Y electrode Y2 and the X electrode X2.

A cell Cij is formed by an intersection between the Y electrode Yi, the address electrode Aj, and the adjacent X electrode Xi corresponding thereto. This cell Cij corresponds to, for example, sub-pixels in red, green and blue, and one pixel is constituted by these three colors sub-pixels. The plasma display panel 10 displays an image by lightings of the plural pixels disposed in two-dimensional matrix. The scan circuits 21, 22 in the Y electrode driver 20, and the address driver 40 determine which cells are to be lighted, and a display operation is performed by performing the discharges repeatedly by the sustain circuit 23 in the Y electrode driver 20 and the sustain circuit 31 in the X electrode driver 30.

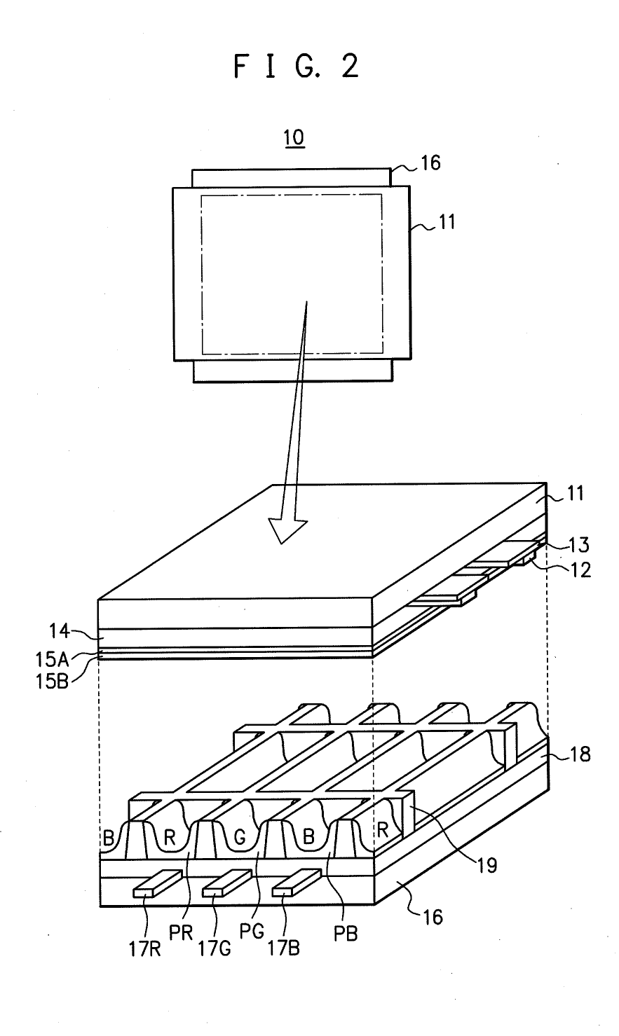

FIG. 2 is an exploded perspective view showing a configuration example of the plasma display panel 10 in the present embodiment.

Display electrodes (also called as sustain electrodes) constituted by a bus electrode (metal electrode) 12, and a transparent electrode 13 are formed on a front glass substrate 11. The display electrodes (12, 13) correspond to the Y electrode Yi and the X electrode Xi shown in FIG. 1. A dielectric layer 14 is provided on the display electrodes (12, 13), and an MgO (magnesium oxide) protective layer 15A is provided further thereon. Further, a priming particle emissive layer 15B is provided on the MgO protective layer 15A. Namely, the display electrodes (12, 13) disposed on the front glass substrate 11 are covered by the dielectric layer 14, a surface thereof is further covered by the MgO protective layer 15A, and a surface thereof is covered by the priming particle emissive layer 15B.

Address electrodes 17R, 17G, 17B are formed on a rear glass substrate 16 disposed to face the front glass substrate 11 in an orthogonal direction (so as to intersect) with the display electrodes (12, 13). The address electrodes 17R, 17G, 17B correspond to the address electrodes Aj shown in FIG. 1. A dielectric layer 18 is provided on the address electrodes 17R, 17G, 17B.

Further, a closed rib 19 disposed in a grid pattern, namely dividing a discharge space into each cell, and phosphor layers PR, PG, PB emitting visible light in red (R), green (G), and blue (B) for color display are formed on the dielectric layer 18. The phosphor layers PR, PG, PB are excited by ultraviolet ray generated by a surface discharge between the paired display electrodes (12, 13), and respective colors emit light.

The rib 19 is constituted by longitudinal ribs formed in a direction where the address electrodes 17R, 17G, 17B are extending and transverse ribs formed in a direction where the display electrodes (12, 13) are extending. Namely, the plasma display panel 10 according to the present embodiment has a closed rib structure.

Among the phosphor layers PR, PG, PB, the phosphor layer PR emitting light in red is formed above the address electrode 17R, the phosphor layer PG emitting light in green is formed above the address electrode 17G, and the phosphor layer PB emitting light in blue is formed above the address electrode 17B. In other words, the address electrodes 17R, 17G, 17B are disposed so as to correspond to the phosphor layers PR, PG, PB in red, green, and blue coated on an inner surface of the rib 19 corresponding to the cells.

The plasma display panel 10 is constituted by sealing the front glass substrate 11 and the rear glass substrate 16 so that a protective layer 15 and the rib 19 are brought into contact, and sealing discharge gas such as Ne—Xe inside thereof (the discharge space between the front glass substrate 11 and the rear glass substrate 16).

Here, the priming particle emissive layer 15B is a functional film to make an address discharge performed during the address period high speed by supplying priming particles. The priming particle emissive layer 15B is constituted by using a priming particle emissive material including MgO (magnesium oxide) crystallization in which, for example, halogen element is added from 1 ppm to 10000 ppm. Incidentally, the priming particle emissive layer 15B may be disposed anywhere within the discharge space so as to expose in the discharge space without being limited to on the MgO protective layer 15A. It is possible to suppress a discharge delay of the address discharge even when an idle period from a previous discharge to the address discharge is long, by providing this priming particle emissive layer 15B.

As an example, a suppression effect of the discharge delay of the address discharge in a plasma display, in which the priming particle emissive layer 15B is formed by using the MgO crystallization to which fluorine is added, will be described below.

At first, the priming particle emissive layer 15B is formed as stated below.

MgO crystallization (manufactured by Ube Materials Co., Ltd., brand name: High Purity and Ultrafine Single Crystal Magnesia Powder (2000A)) and MgF₂ (magnesium fluoride) (manufactured by Furuuchi Chemical Corporation, purity: 99.99%) are respectively aggregated and broken to be fine particle state by using a mortar and a pestle. Next, the aggregated and broken MgO crystallization and MgF₂ are weighed and mixed by using a tumbler mixing machine so that a mixed amount (mol %) of MgF₂ becomes 0.01.

Next, the mixture is burned at 1450° C. in the atmosphere for one hour, and thereafter, the burned powder is aggregated and broken to be fine particle state, and the MgO crystallization to which fluorine is added, is obtained. Incidentally, an added amount of fluorine was 80 ppm as a result of being measured by a combustion ion chromatography analysis.

The MgO crystallization, to which fluorine is added manufactured as stated above, is mixed to IPA (isopropyl alcohol: manufactured by Kantou Chemical Co., Ltd., for electronic industry) with a ratio of 2 g for 1 L of IPA, then dispersed by an ultrasonic dispersion machine, aggregated and broken, and slurry is manufactured. A process in which this slurry is spray-coated on the MgO protective layer 15A by using a spray gun for painting, and thereafter, it is dried by spraying dry air, is repeated for several times, to thereby form the priming particle emissive layer 15B. The priming particle emissive layer 15B is formed so that a weight of the MgO crystallization to which fluorine is added becomes 2 g per 1 m².

Incidentally, the other constitutions in the plasma display panel are as stated below.

Width of display electrode 12: 95 μm

Width of display electrode 13: 270 μm

Width of discharge gap: 100 μm

Dielectric layer 14: formed by coating and burning low-melting glass paste, thickness thereof: 30 μm

MgO protective layer 15A: formed by an electron beam evaporation method, thickness thereof: 7500 Å

Width of address electrode 17: 70 μm

Dielectric layer 18: formed by coating and burning the low-melting glass paste, thickness thereof: 10 μm

Thickness of phosphor layer at right above the address electrode 17: 20 μm

Material of phosphor layer: Zn₂SiO₄: Mn (green phosphor)

Height of rib 19: 140 μm, Width at top portion of rib 19: 50 μm

Pitch of rib 19: 360 μm

Discharge gas: Ne 96% - Xe 4%, 500 Torr

Next, a discharge delay test is performed for the manufactured plasma display panel.

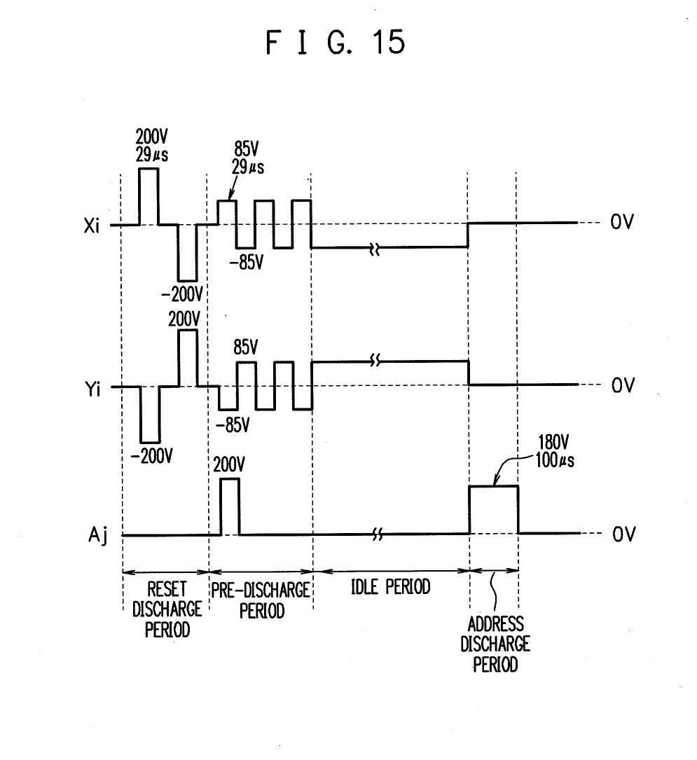

The discharge delay test is performed by voltage waveforms for measurement shown in FIG. 15. A charge state of the dielectric layer is initialized by bringing about a reset discharge between the X electrode Xi and the Y electrode Yi during the reset discharge period, to remove an effect of a previous discharge. During a pre-discharge period, the priming particle emissive material is excited by bringing about the discharge between the X electrode Xi and the Y electrode Yi after a specific cell is selected. After that, the voltage is applied to the address electrode Aj during the address discharge period after the idle period elapsed, and time is measured from this voltage applying time to an actual start time of discharging. The time until the start of discharging is measured for 1000 times, and the time when a cumulative discharge probability becomes 90% is defined as the discharge delay.

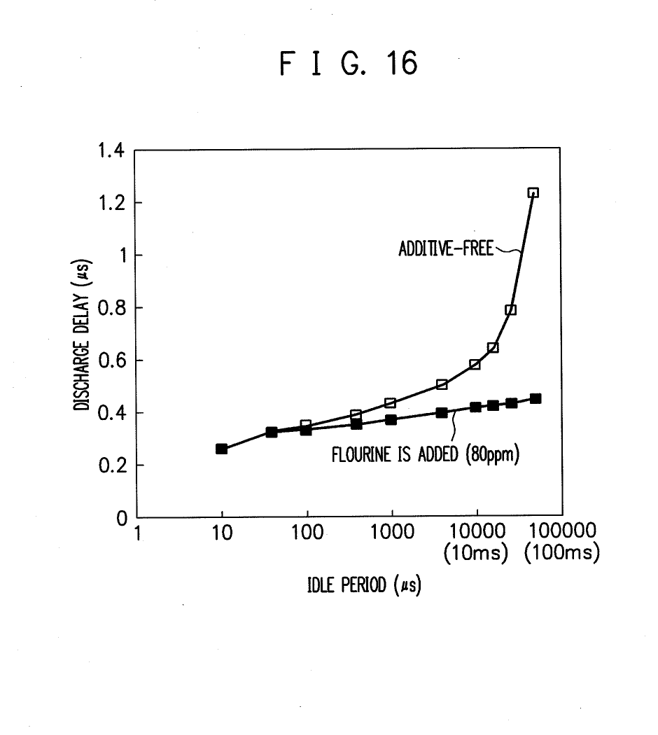

A result obtained as stated above is shown in FIG. 16. FIG. 16 is a graphic chart showing a relation between the idle period and the discharge delay as for the plasma display panel manufactured by using the MgO crystallization to which fluorine is added. Incidentally, a relation between the idle period and the discharge delay as for a plasma display panel manufactured by using the MgO crystallization to which fluorine is not added (additive-free) is also shown in FIG. 16 for comparative reference.

As it is obvious from FIG. 16, in the plasma display panel manufactured by using the MgO crystallization to which fluorine is added (amount of added fluorine: 80 ppm), the discharge delay is short even at a place where the idle period is long compared to the plasma display panel manufactured by using the MgO crystallization to which fluorine is not added. In the plasma display panel manufactured by using the MgO crystallization with the amount of added fluorine of 80 ppm, it can be seen that the discharge delay does not deteriorate significantly until the idle period is approximately 100 ms.

FIG. 3 is a view for explaining dispositions of the display electrodes in the plasma display panel 10 in the present embodiment.

Longitudinal ribs 19A are formed at both sides of the not-shown address electrode Aj, and transverse ribs 19B are formed so as to intersect with the longitudinal ribs 19A. The discharge space is divided by the longitudinal ribs 19A and the transverse ribs 19B to form the cells, and the display line is formed by the plural cells being in line in a horizontal direction (in a direction where the transverse ribs 19B are extending).

The display electrode constituted by the bus electrode 12 and the transparent electrode 13 is formed in the direction where the transverse rib 19B is extending, and a pair (two pieces) of display electrodes (12, 13) is disposed by each display line without sharing the display electrode with the adjacent display line. The display electrodes (12, 13) are disposed so that a disposed position of the X electrode and Y electrode is reversed relative to the adjacent display line. For example, the X electrode X(2n+1), the Y electrode Y(2n+1) are disposed in this sequence at the (2n+1)th display line, the Y electrode Y(2n+2), the X electrode X(2n+2) are disposed in this sequence at the (2n+2)th display line adjacent thereto, as shown in FIG. 3. Namely, the X electrodes with each other or the Y electrodes with each other at the adjacent display lines are disposed so as to be adjacent to while sandwiching the transverse rib 19B.

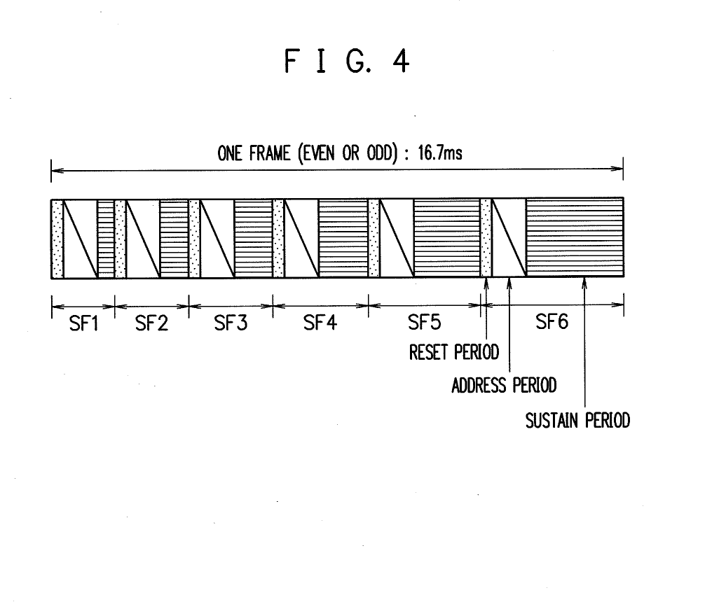

FIG. 4 is a view for explaining an example of a driving method of a general plasma display panel. One frame (odd frame or even frame) is constituted by plural sub-frames (SFs). In FIG. 4, a constitution in which one frame is composed of six sub-frames SF1, SF2, SF3, SF4, SF5, SF6 is shown as a matter of convenience for drawing, but a constitution in which one frame is composed of 10 to 12 sub-frames is normal.

Each of the sub-frames SF1 to SF6 is constituted by the reset period, the address period, and the sustain period. The wall charge state on the electrode is initialized during the reset period, the cells to be lighted are selected by adjusting the wall charge state based on the display data during the address period, and the cells corresponding to the display data are lighted during the sustain period (a discharge light emission is performed at the cells selected in accordance with the display data). The gradation expression is realized by selecting the sub-frames SF1 to SF6 to be lighted.

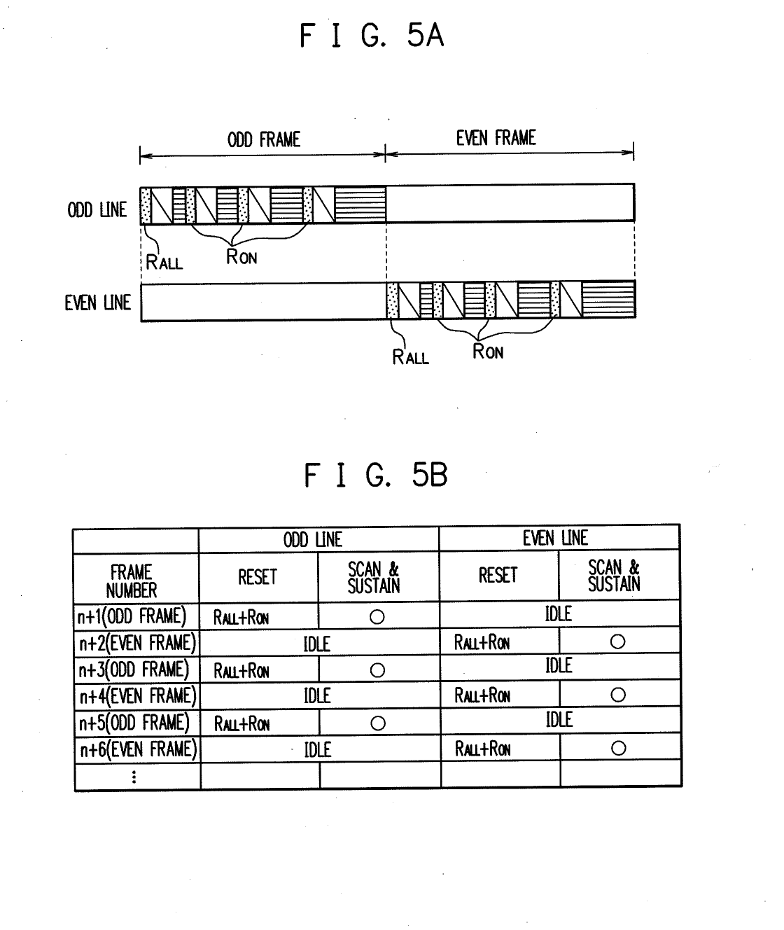

FIG. 5A and FIG. 5B are views for explaining an example of the driving method of the plasma display device in the present embodiment. In FIG. 5A and FIG. 5B, an example of an interlace drive in one line display, namely the odd display lines are lighted and the even display lines are not lighted in the odd frames, and the even display lines are lighted and the odd display lines are not lighted in the even frames, is shown.

FIG. 5A is a view showing an example of a driving configuration of the plasma display device in the present embodiment. In FIG. 5A, each of the odd frame and the even frame has a constitution composed of four sub-frames as a matter of convenience for drawing.

In the interlace drive in one line display in the present embodiment, an all-cell reset R_{ALL} in which the reset discharge is performed at all cells is performed for the odd display lines, at a head sub-frame in the odd frame in which the sustain discharge is performed only at the odd display lines and only the odd display lines are lighted. An on-cell reset R_{ON} in which the reset discharge is performed only at the cells lighted during the sustain period of the previous sub-frame, namely, only at the cells where the sustain discharge is performed, is performed at the sub-frames other than the head sub-frame.

Besides, the all-cell reset R_{ALL} is performed for the even display lines at a head sub-frame, and the on-cell reset R_{ON} is performed at the sub-frames other than the head sub-frame, at the even frame in which the sustain discharge is performed only at the even display lines and only the even display lines are lighted.

Namely, in the interlace drive in one line display, the all-cell reset R_{ALL} of once is performed by each frame for the odd display lines in the odd frames n+1, n+3, n+5, . . . of which frame numbers are odd, and the on-cell reset R_{ON} is performed other than the head sub-frame, as shown in FIG. 5B. Incidentally, the even display lines are in the idle state in the odd frames n+1, n+3, n+5, . . . .

Similarly, the all-cell reset R_{ALL} of once is performed by each frame for the even display lines in the even frames n+2, n+4, n+6, . . . of which frame numbers are even, and the on-cell reset R_{ON} is performed other than the head sub-frame. Incidentally, the odd display lines are in the idle state in the even frames n+2, n+4, n+6, . . . .

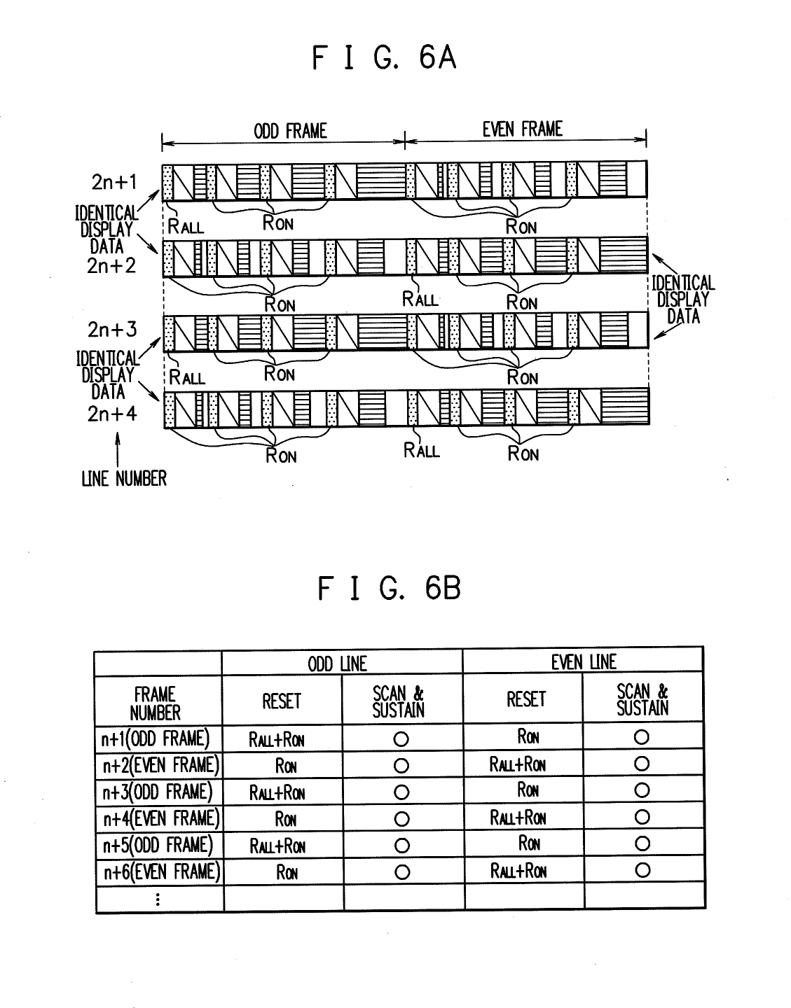

FIG. 6A and FIG. 6B are views for explaining another example of the driving method of the plasma display device in the present embodiment. An example in which the interlace drive in two lines display, for more detail, the two lines display is performed partially is shown in FIG. 6A and FIG. 6B. Namely, in the example shown in FIG. 6A and FIG. 6B, the odd display lines are lighted for a whole period and the even display lines are lighted for a partial period in the odd frame, and the even display lines are lighted for a whole period and the odd display lines are lighted for a partial period in the even frame. Incidentally, the partial period may be the whole within an arbitrary sub-frame among the sub-frames constituting the frame, or may be a part within the sub-frame.

FIG. 6A is a view showing another example of the driving configuration of the plasma display device in the present embodiment. In FIG. 6A, each of the odd frame and the even frame has a constitution composed of four sub-frames as a matter of convenience for drawing.

Incidentally, in the example shown in FIG. 6A, an identical display data is written to a (2n+1)th line being the odd display line and a (2n+2)th line being the even display line, and another identical display data is written to a (2n+3)th line being the odd display line and a (2n+4)th line being the even display line, in the odd frame. Besides, the other identical display data is written to the (2n+2)th line being the even display line and the (2n+3)th line being the odd display line, in the even frame.

In the example of the interlace drive in two lines display shown in FIG. 6A and FIG. 6B, the all-cell reset R_{ALL} is performed for the odd display lines at the head sub-frame in the odd frame. Besides, the on-cell reset R_{ON} is performed at the sub-frames other than the head sub-frame as for the odd display lines, and at all of the sub-frames as for the even display lines.

Similarly, in case of the even frame, the all-cell reset R_{ALL} is performed for the even display lines at the head sub-frame. Besides, the on-cell reset R_{ON} is performed at the sub-frames other than the head sub-frame as for the even display lines, and at all of the sub-frames as for the odd display lines.

Namely, in the interlace drive in two lines display, as shown in FIG. 6B, in the odd frames n+1, n+3, n+5, . . . of which frame numbers are odd, the all-cell reset R_{ALL} of once is performed by each frame for the odd display lines, but only the on-cell reset R_{ON} is performed for the even display lines. On the other hand, in the even frames n+2, n+4, n+6, . . . of which frame numbers are even, the all-cell reset R_{ALL} of once is performed by each frame for the number display lines, but only the on-cell reset R_{ON} is performed for the odd display lines.

Namely, in the example shown in FIG. 6A and FIG. 6B, the all-cell reset R_{ALL} is performed for the odd frame in the odd display lines, and the all-cell reset R_{ALL} is performed for the even frame in the even display lines. Accordingly, it becomes possible to suppress that the number of times of the all-cell reset increases, and to suppress the deterioration of the display quality by preventing that the background luminance becomes high, even in the interlace drive in two lines display. Besides, when the all-cell reset R_{ALL} is performed as shown in FIG. 6A and FIG. 6B, the number of times of the all-cell reset R_{ALL} per unit time is the same as the interlace drive in one line display shown in FIG. 5A and FIG. 5B, and therefore, it is possible to prevent the occurrence of the switching shock and to perform the image display without a sense of incompatibility even if the one line display state and the two lines display state are switched while continuing the display operation because the background luminance does not change.

Incidentally, an execution of the all-cell reset R_{ALL} in the interlace drive in two lines display shown in FIG. 6A and FIG. 6B is an example and various modifications are possible without being limited to the above. For example, the all-cell reset R_{ALL} may be performed for both display lines of the odd display lines and the even display lines in the head sub-frame in one of the odd frame or the even frame, or the all-cell reset R_{ALL} of once may be performed in a random order for each of the display lines during the period when the odd frame and the even frame are put together.

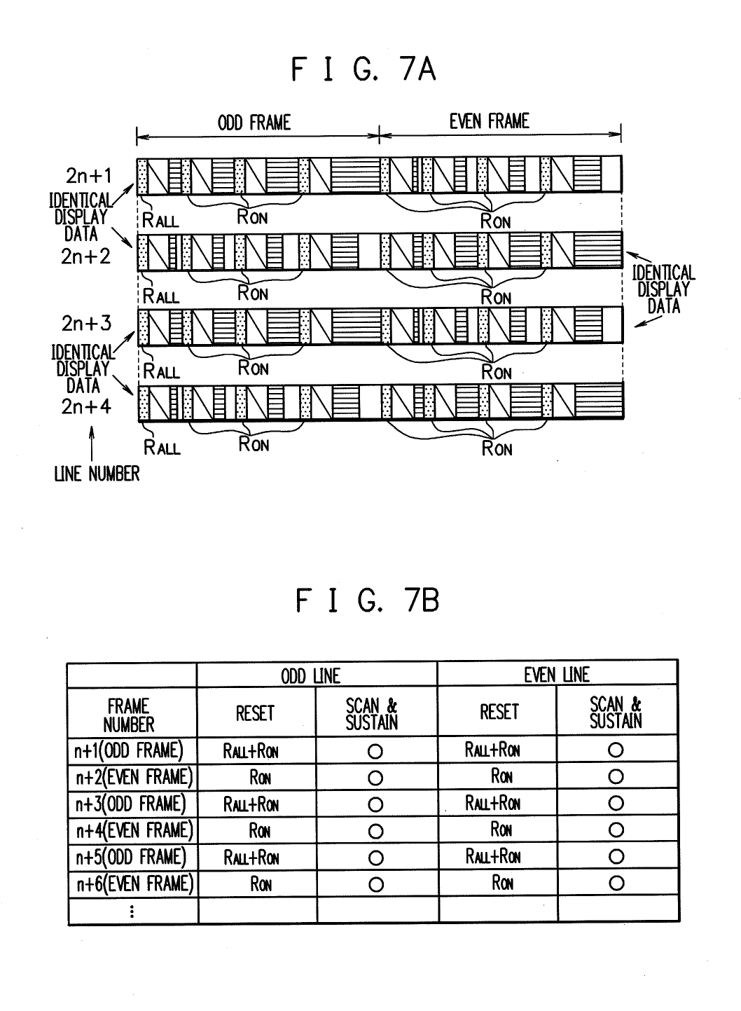

FIG. 7A and FIG. 7B are views for explaining the other example of the driving method of the plasma display device in the present embodiment. The other example of the interlace drive in two lines display is shown in FIG. 7A and FIG. 7B. FIG. 7A shows the other example of the driving configuration of the plasma display device in the present embodiment, and FIG. 7B shows a reset setting in the driving configuration shown in FIG. 7A.

In the example shown in FIG. 7A and FIG. 7B, the all-cell reset R_{ALL} is performed for both display lines of the odd display lines and the even display lines at the head sub-frame of the odd frame, and the on-cell reset R_{ON} is performed at the sub-frames other than the head sub-frame of the odd frame and at all of the sub-frames of the even frame. It is also possible to suppress the increase of the number of times of the all-cell reset, and to suppress the deterioration of the display quality by preventing that the background luminance becomes high also by doing as shown in FIG. 7A and FIG. 7B. Besides, the number of times of the all-cell reset R_{ALL} per unit time is the same as the interlace drive in one line display, and therefore, it is possible to prevent the occurrence of the switching shock if the one line display state and the two lines display state are switched while continuing the display operation because the background luminance does not change.

Incidentally, in the above-stated example, the all-cell reset R_{ALL} is performed at the head sub-frame in one of the odd frame or the even frame, but the present invention is not limited to the above. Namely, it is not limited to the one in which the all-cell reset R_{ALL} of once is performed during the period of two frames in which the odd frame and the even frame are put together, but it may be the one in which the all-cell reset R_{ALL} of once is performed per an arbitrary unit time including plural frames.

As shown in FIG. 16, in the plasma display panel in which the discharge delay does not largely deteriorate until the idle period from the previous discharge to the address discharge is approximately 100 ms, it can be driven normally if the all-cell reset is not performed up to six frames (the period of one frame is 16.6 ms), further a black display (non-lighting of cells) continues and the on-cell reset does not operate. Namely, it is possible to drive the plasma display panel normally, for example, if the all-cell reset R_{ALL} of once is performed per the time for six frames.

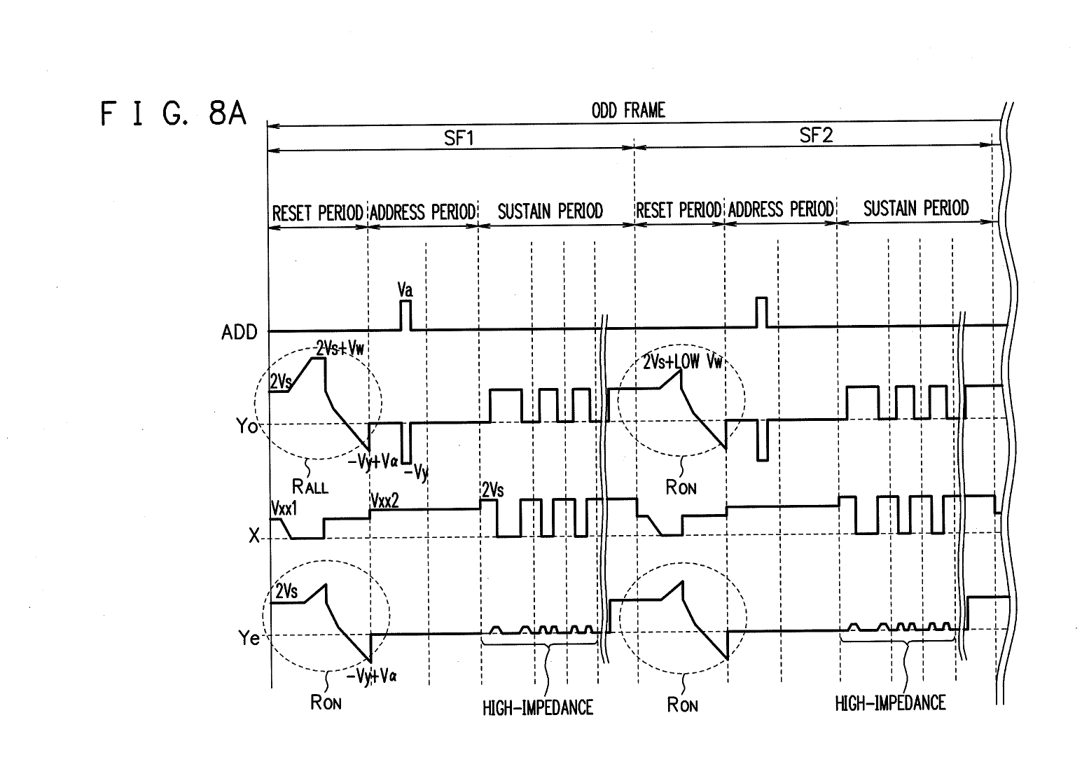

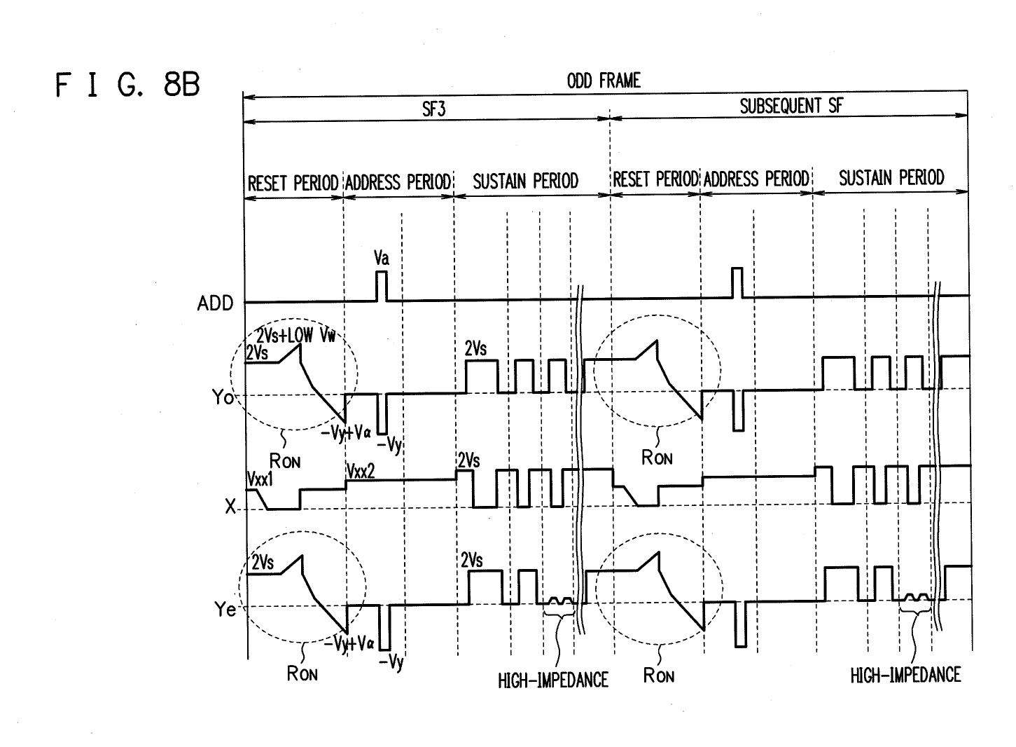

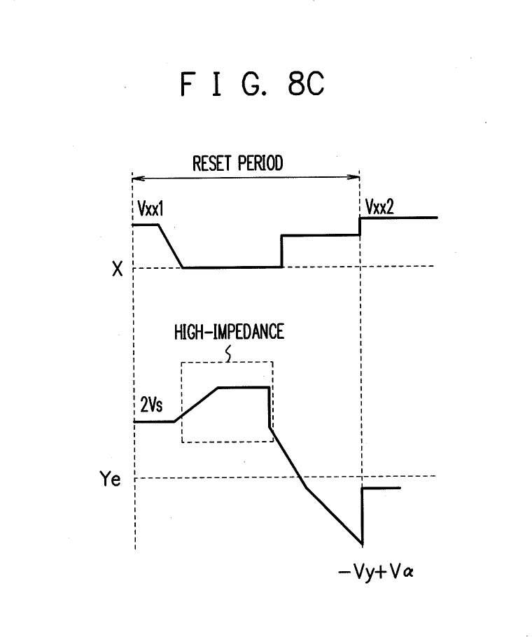

FIG. 8A and FIG. 8B are views showing an example of driving waveforms of the plasma display device in the present embodiment. In FIG. 8A and FIG. 8B, the driving waveforms of the interlace drive in two lines display are shown, and an example of the driving waveforms according to the X electrode Xi, the Y electrode Yi, and the address electrode Aj in the odd frame is shown. In FIG. 8A, the driving waveforms in a first sub-frame (the head sub-frame) SF1 and a second sub-frame SF2 of the odd frame are shown, and the driving waveforms subsequent to FIG. 8A, namely in a third sub-frame SF3 and later of the odd frame, are shown in FIG. 8B. Incidentally, in FIG. 8A and FIG. 8B, “ADD” shows a voltage waveform relating to the address electrode Aj, “Yo” shows the voltage waveform relating to the Y electrode Yi of the odd display line, “X” shows the voltage waveform relating to the X electrode Xi, and “Ye” shows the voltage waveform relating to the Y electrode Yi of the even display line.

During the reset period of the head sub-frame SF1, a reset pulse with a voltage of (2Vs+Vw) is applied to the Y electrode Yi of the odd display line, and thereby, the all-cell reset R_{ALL} is performed for the odd display line. On the other hand, the reset pulse with a voltage of (2Vs+low Vw) is applied to the Y electrode Yi of the odd display line, and thereby, the on-cell reset R_{ON} is performed for the even display line. Here, (low Vw) is lower than (Vw). Besides, during each of the reset periods of the second sub-frame SF2 and later, the reset pulse with the voltage of (2Vs+low Vw) is applied to the Y electrodes Yi of the odd display line and the even display line, and thereby, the on-cell reset R_{ON} is performed for each of the display lines.

Incidentally, in the example shown in FIG. 8A and FIG. 8B, the Y electrode Yi of the even display line is made into a high-impedance state, and the one line display only by the odd display line is performed in the first and second sub-frames SF1, SF2. Besides, in the third and later sub-frames, a sustain pulse is applied to the Y electrode Yi of the even display line at a front portion of sustain period, and made into the high-impedance state at a rear portion. Accordingly, in the third and later sub-frames, the two lines display by the odd display line and the even display line is performed at the front portion of sustain period, and the one line display only by the odd display line is performed at the rear portion of sustain period.

Incidentally, the reset pulse with the voltage of (2Vs+low Vw) is applied to the Y electrode Yi of the even display line during the reset period of the head sub-frame SF1 to perform the on-cell reset R_{ON} for the even display line in FIG. 8A, but the Y electrode Yi of the even display line may be made into the high-impedance state as shown in FIG. 8C.

As stated above, when the two lines display is performed by applying the sustain pulse to the Y electrodes Yi of the odd display line and the even display line at the first period during the sustain period, and the one line display is performed by applying the sustain pulse only to the Y electrode Yi of one of the display lines either the odd display line or the even display line at the second period, the switch SW1 to connect the scan circuit (even) 21 and the sustain circuit 23, the switch SW2 to connect the scan circuit (odd) 22 and the sustain circuit 23 are to be controlled appropriately during the sustain period.

Namely, when the sustain pulse is applied to the Y electrode Yi of the odd display line, the switch SW2 is turned on state, and the switch SW2 is turned off state when it is made into the high-impedance state. When the sustain pulse is applied to the Y electrode Yi of the even display line, the switch SW1 is turned on state, and the switch SW1 is turned off state when it is made into the high-impedance state.

The two lines display is performed as stated above, and thereby, it is possible to obtain higher luminance than the interlace drive in one line display. Besides, when the two lines display is performed partially, the image becomes an intermediate between the one line display and the two lines display. Here, when the two lines display is performed partially, a ratio of the number of sustain discharges of fewer side relative to the number of discharges of the other, in other words, it is a time ratio of a first period of the sustain period relative to the sustain period, and a mixing ratio showing a ratio of the two lines display (two lines simultaneous lighting) is set to be “α”, in which 0<“α”<1.

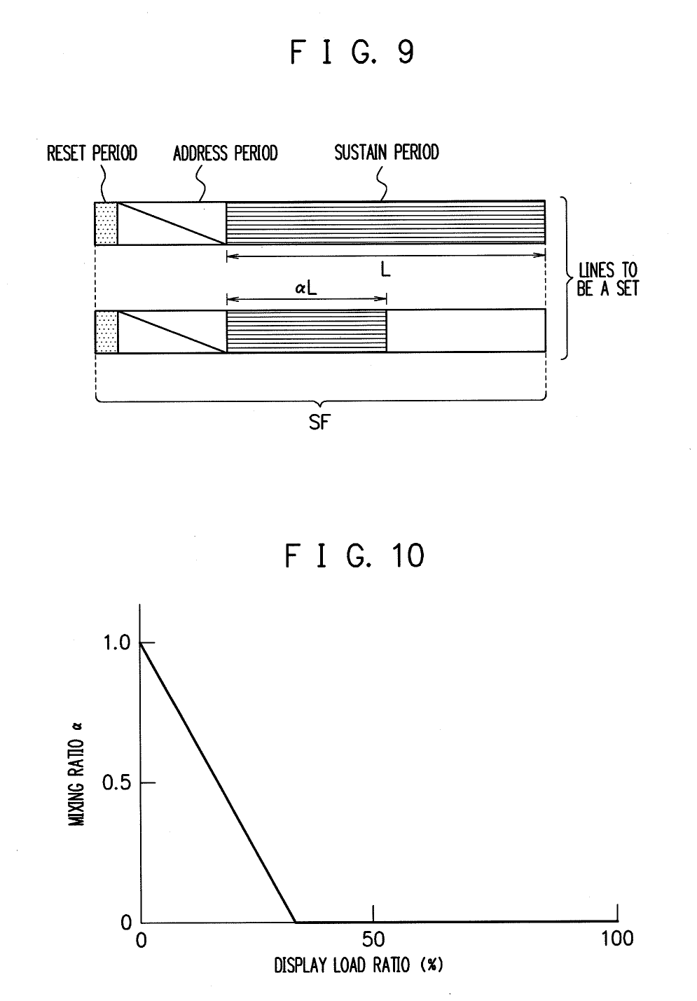

Namely, luminance when a line which does not decrease the number of sustain discharges in a sub-frame is all lighted is set as “L”, luminance when the other line is all lighted is “αL”, as a driving configuration in which only one sub-frame is picked up is shown in FIG. 9. It is desirable that a value of “α” is necessary to be 0.05 or more to obtain the luminance improvement even if there is manufacturing variability. Besides, it is preferable that the value of “α” is necessary to be 0.2 or more to obtain more effect of the luminance improvement. On the other hand, it is preferable that the value of “α” is necessary to be 0.8 or less, and more preferably to be 0.5 or less to obtain an effect of resolution improvement.

Hereinafter, an example of a setting method of the mixing ratio “α” is described.

Incidentally, in the example shown below, the mixing ratio “α” is changed linearly relative to a change of the display load ratio of the plasma display panel, but the change of the mixing ratio “α” relative to the change of the display load ratio may be nonlinear without being limited to the above.

(1) As shown in FIG. 10, the mixing ratio “α” of the two lines lighting is set to be “0” (zero) when the display load ratio of the plasma display panel is higher than a certain value (a first threshold value) and the mixing ratio “α” is increased gradually in accordance with a decrease of the display load ratio when it is not more than the first threshold value.

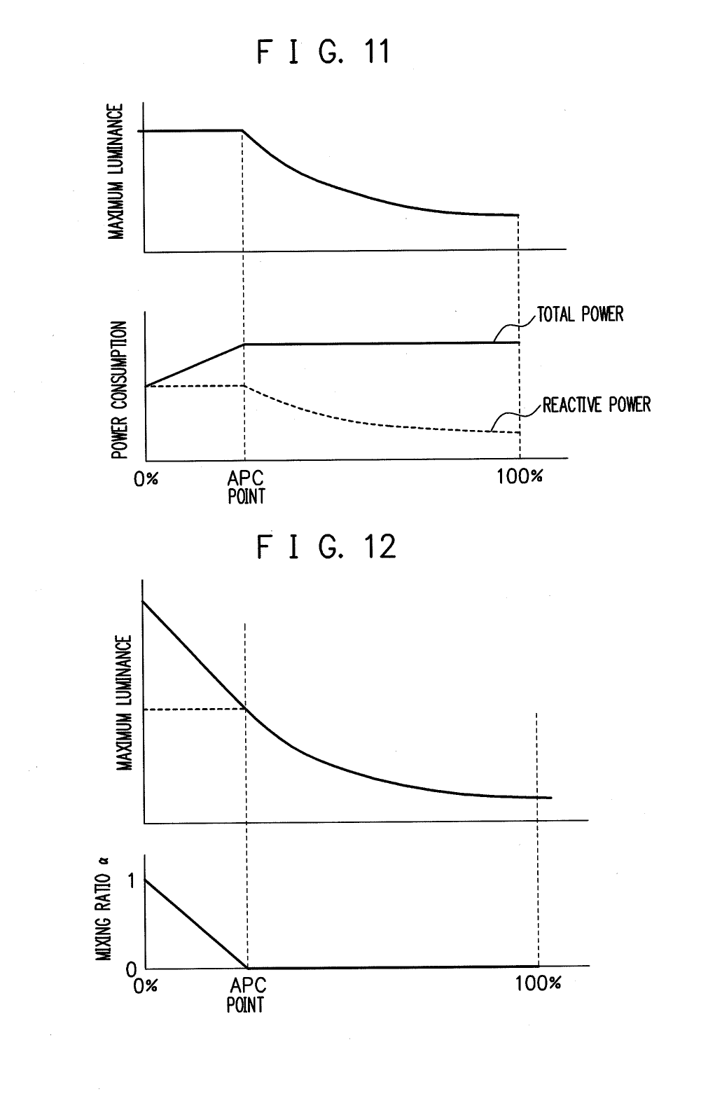

When the two lines display is performed, luminance per a unit sustain period increases approximately in proportion to the mixing ratio “α” of the two lines lighting, but light emission efficiency is approximately the same. On the other hand, in a normal plasma display panel, an APC (Automatic Power Control) control or an APL (Average Picture Level) control as shown in FIG. 11 is performed.

Hereinafter, the APC control in the plasma display panel is described. Incidentally, power consumption of the plasma display panel is only electric power consumed during the sustain period as a matter of convenience for the explanation because a substance of an argument is not changed. Here, the electric power consumed during the sustain period is composed of discharge power directly contributing to the light-emission and reactive power consumed when capacitance between electrodes is charged and discharged. A relation between maximum luminance (luminance at the maximum gradation time) relative to the display load ratio and the power consumption is shown in FIG. 11. The maximum luminance and the reactive power are approximately in proportion to a sustain frequency. The sustain frequency (the maximum luminance and the reactive power) is kept constant at under an APC point (a point on the display load ratio where the APC control (or the APL control) begins to work: normally, the display load ratio is from 10% to 20%) , and the sustain frequency (the maximum luminance and the reactive power) decreases as the increase of the display load ratio at above the APC point. On the other hand, total power increases as the increase of the display load ratio at under the APC point, and the total power is kept constant at above the APC point. This is the normal APC control.

Consequently, if the two lines lighting is performed at an area of high display load ratio where the control is performed so as to keep the total power in constant (for example, an area above the APC point), there is almost no effect of luminance increase though the resolution decreases relative to the one line lighting. In the two lines lighting, the luminance per one sustain cycle becomes approximately double, but the power consumption also increases. Accordingly, the sustain frequency at the two lines lighting time becomes lowered compared to the sustain frequency at the one line lighting time under the control of keeping total power constant. As a result, the maximum luminance scarcely increases.

According to these circumstances, the control of the two lines lighting is performed when the display load ratio of the plasma display panel is not more than the first threshold value. As an example, the maximum luminance (the luminance at the maximum gradation time) relative to the display load ratio and the mixing ratio “α” are shown in FIG. 12 when the control is performed so that the mixing ratio “α” of the two lines lighting is increased in accordance with the decrease of the display load ratio at the area where the display load ratio is lower than the APC point. The maximum luminance increases by increasing the mixing ratio “α” of the two lines lighting in accordance with the display load ratio at the area where the display load ratio is lower than the APC point.

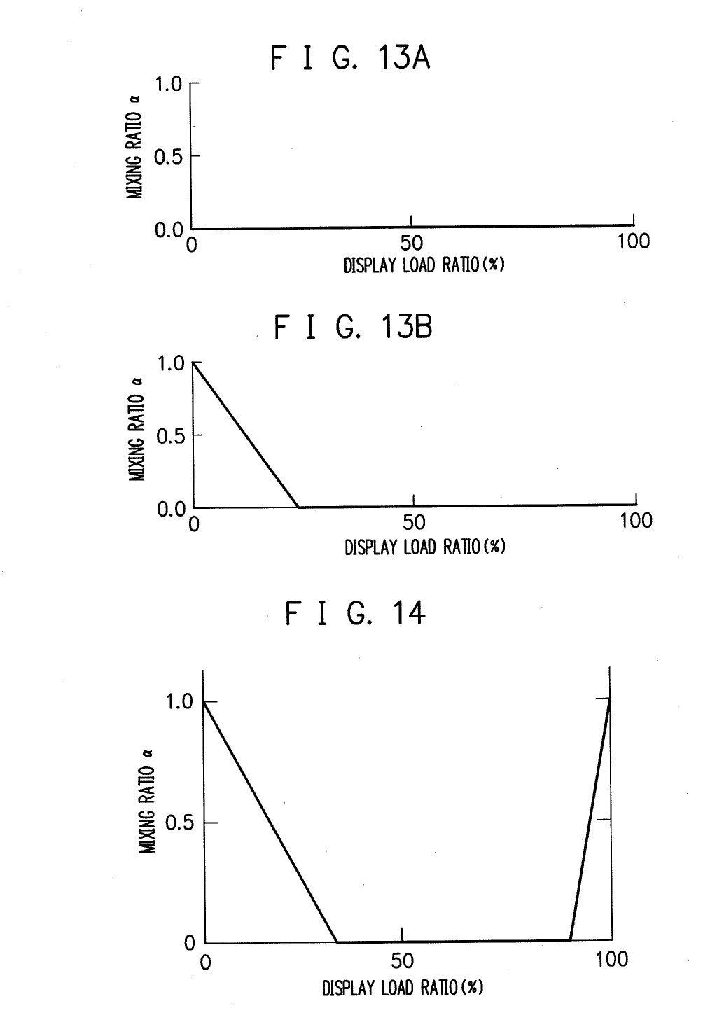

(2) As shown in FIG. 13A and FIG. 13B, the control of the two lines lighting is not performed at lower sub-frames of which luminance weight is light (FIG. 13A), and the control of the two lines lighting is performed only at upper sub-frames of which the luminance weight is heavy (FIG. 13B). Namely, the mixing ratio “α” of the two lines lighting is constantly set to be “0” (zero) regardless of the display load ratio of the plasma display panel at the lower sub-frames. Besides, the mixing ratio “α” of the two lines lighting is set to be “0” (zero) when the display load ratio is higher than a curtain value (the first threshold value), and the mixing ratio “α” is gradually increased as the display load ratio decreases when the display load ratio is not more than the first threshold value, at the upper sub-frames.

In the above-stated setting method of (1), the mixing ratio “α” of the two lines lighting is uniformly controlled at all of the sub-frames, but the effect of performing the two lines lighting is little because the number of sustain discharges (the number of sustain pulses) is few at the lower sub-frames where the luminance weight is light (the drive time does not increase so much if the total number of pulses is increased to increase the luminance under a state of one line lighting). It is more important to make the minimum luminance little than to perform the two lines lighting at the lower sub-frames to output the gradation finely. Accordingly, the control of the two lines lighting is not performed at the lower sub-frames as shown in FIG. 13A, and the control of the two lines lighting according to the display load ratio is performed at the upper sub-frames as shown in FIG. 13B.

(3) As shown in FIG. 14, the mixing ratio “α” is increased gradually as the display load ratio decreases when the display load ratio of the plasma display panel is not more than the first threshold value, the mixing ratio “α” of the two lines lighting is set to be “0” (zero) when the display load ratio is higher than the first threshold value and not more than a second threshold value, and the mixing ratio “α” is increased gradually as the display load ratio increases when the display load ratio is higher than the second threshold value.

At the area of the high display load ratio, large luminance improvement owing to the two lines lighting does not occur because the control is performed so that the total power is kept constant in the APC control as stated above. However, there is a reactive power consumption caused by the charge and discharge for line-to-line capacitance even if the non-lighting line is not lighted at the one line lighting time. Accordingly, a value of the reactive power relative to the number of lighting cells decreases when the two lines lighting is performed, and therefore, it is possible to realize the luminance increase for the amount that the reactive power decreases. Besides, at an area where the display load ratio is in a vicinity of 100%, the resolution is not required so much because all over the image is near to a state of monochromatic while.

It becomes possible to decrease the reactive power and to improve the luminance by increasing the mixing ratio “α” of the two lines lighting in accordance with the display load ratio at the area where the display load ratio is in the vicinity of 100% in which the resolution is not required that much.

Besides, in the above-stated example, the mixing ratio “α” can take every value within a range of “0” (zero) to one, but the present invention is not limited to the above. For example, the mixing ratio “α” may be controlled so as not to be the value of 0.2 or less, or so as not to be the value of 0.8 or more.

Besides, the above-described embodiments are to be considered in all respects as illustrative and no restrictive. Namely, the present invention may be embodied in other specific forms without departing from the spirit or essential characteristics thereof.

What is claimed is:

1. A plasma display device, comprising:
a plasma display panel in which display electrode pairs of even display lines and display electrode pairs of odd display lines are arranged alternately; and
a driving unit performing an interlace drive by applying a sustain pulse to one of the display electrode pairs either the display electrode pair of the even display lines or the display electrode pair of the odd display lines in each frame in a first mode, and performing the interlace driving by applying the sustain pulse while setting the two display electrode pairs of the even display lines and the odd display lines adjacent above and below as one set, and writing an identical data thereto in a second mode, and
wherein an all-cell reset performing a reset discharge initializing a wall charge state on an electrode at all cells is performed once per unit time including plural frames, when said plasma display panel is driven in the second mode.

2. The plasma display device according to claim 1, further comprising:
a display load ratio detecting unit detecting a display load ratio of said plasma display panel,
wherein said plasma display panel is driven by selecting the first mode or the second mode in accordance with the display load ratio detected by said display load ratio detecting unit.

3. The plasma display device according to claim 2,
wherein the first mode is selected when the display load ratio detected by said display load ratio detecting unit is higher than a threshold value, and the second mode is selected when the display load ratio is not more than the threshold value.

4. The plasma display device according to claim 1,
wherein the number of execution times of the all-cell reset per unit time is the same between the first mode and the second mode.

5. The plasma display device according to claim 1,
wherein the frame is constituted by plural sub-frames, and said plasma display panel is driven so that the frame in which the all-cell reset is performed and the frame in which only an on-cell reset performing the reset discharge only at a cell lighted at a preceding sub-frame is performed are disposed alternately when said plasma display panel is driven in the second mode.

6. The plasma display device according to claim 1,
wherein the all-cell reset is performed only for the odd display lines in odd frame, and the all-cell reset is performed only for the even display lines in even frame.

7. The plasma display device according to claim 1,
wherein said plasma display panel has a priming particle emissive layer disposed to expose to a discharge space between two substrates sealed to face.

8. The plasma display device according to claim 7,
wherein the priming particle emissive layer includes magnesium oxide crystallization in which halogen element is added from 1 ppm to 10000 ppm.

9. The plasma display device according to claim 1,
wherein a scan electrode of the other display electrode pair to which the sustain pulse is not applied is made into a high-impedance state when said plasma display panel is driven in the first mode.

10. A driving method of a plasma display device having a plasma display panel in which display electrode pairs of even display lines and display electrode pairs of odd display lines are arranged alternately, comprising:
detecting a display load ratio of the plasma display panel;
selecting a first mode or a second mode in accordance with the detected display load ratio;
performing an interlace drive by applying a sustain pulse to one of the display electrode pairs either the display electrode pair of the even display lines or the display electrode pair of the odd display lines in each frame in the first mode;
performing the interlace drive by applying the sustain pulse while setting the two display electrode pairs of the even display lines and the odd display lines adjacent above and below as one set, and writing an identical data thereto in the second mode; and
performing an all-cell reset in which a reset discharge initializing a wall charge state on an electrode is performed at all cells once per unit time including plural frames when the plasma display panel is driven in the second mode.
